(19) United States
(12) Patent Application Publication
(10) Pub. No.: US 2026/0166999 A1
(43) Pub. Date: Jun. 18, 2026

(54) CAMERA MIRROR SYSTEM

(71) Applicant: SL Mirrortech Corporation, Siheung-si (KR)

(72) Inventors: Hyungsik YOON, Siheung-si (KR); Wondal JANG, Siheung-si (KR); Muyoul LEE, Siheung-si (KR); Changwoo HA, Siheung-si (KR)

(21) Appl. No.: 19/390,381

(22) Filed: Nov. 14, 2025

(30) Foreign Application Priority Data
Nov. 27, 2024 (KR) 10-2024-0171721
Sep. 15, 2025 (KR) 10-2025-0132090

(51) Int. Cl. B60K 35/90; B60K 35/10; B60R 1/00; B60R 1/26

(52) U.S. Cl. CPC B60K 35/90; B60K 35/10; B60R 1/006; B60R 1/26; B60K 2360/21; B60R 2300/8066

(57) ABSTRACT

A camera mirror system includes a camera disposed at a side of a vehicle and captures a rear view or side-rear view around the vehicle; a display device that outputs an image captured by the camera; and a control device configured to relay the image between the camera and the display device. The control device is configured to: calculate calibration information for calibrating an installation error of the camera; set an extended area obtained by extending a reference area preset in an original image generated by the camera based on the calibration information; extract an extended image corresponding to the extended area from the original image; and transmit a display image corresponding to a display area selected by a user within the extended image to the display device.

### CROSS-REFERENCE TO RELATED APPLICATIONS

This application claims priority from Korean Patent Applications Nos. 10-2024-0171721 filed on Nov. 27, 2024 and 10-2025-0132090 filed on Sep. 15, 2025. The aforementioned applications are incorporated herein by reference in their entireties.

### BACKGROUND

### 1. Technical Field

The present disclosure relates to a camera mirror system, and more particularly, to a camera mirror system that aligns screen information such as an On Screen Display (OSD) with an image based on calibration information for calibrating an installation error of a camera mirror provided in a vehicle.

### 2. Description of Related Art

A Camera Mirror System (CMS) refers to a system that provides a driver with an image of the surroundings around a vehicle captured by a camera. The driver may secure a field of side-rear view of the vehicle using the image captured by the camera disposed on each of both opposing sides of the vehicle.

In order to construct a camera mirror system, installation of the camera in each of both opposing housings of a vehicle may be performed. In this regard, the directions in which both cameras are oriented may be slightly different for each installation, based on the installation work environment. When the orientation direction of the camera is not accurate, the CMS cannot provide a correct view to the driver.

Accordingly, an error calibration of moving a position of the image regardless of the orientation direction of the camera may be performed. The error calibration operation may be performed so that a specific area of the image captured by the camera is included in the screen.

A pattern board may be used to perform the error calibration operation. The user may perform the error calibration by referring to the pattern board included in an image generated by the camera (hereinafter, referred to as an original image). Specifically, the user may determine a position of a reference area so that the pattern board is included in the reference area of the original image. Accordingly, screen information such as an On Screen Display (OSD) may be aligned with the reference area.

When the reference area and the screen information are aligned with each other by adjusting the position of the reference area in an entire area of the original image, the image information provided to the user may be limited depending on the position of the reference area.

Accordingly, there is a need for a scheme of enabling the screen information to be aligned with the reference area in a state in which the position of the reference area is not adjusted.

### SUMMARY

A technical purpose of the present disclosure is to provide a camera mirror system for aligning screen information such as an On Screen Display (OSD) with an image based on calibration information for calibrating an installation error of a camera mirror provided in a vehicle.

The technical purposes of the present disclosure are not limited to those mentioned above, and other technical purposes not mentioned may be clearly understood by those skilled in the art from descriptions as set forth below.

A camera mirror system according to one aspect of the present disclosure may include a camera (e.g., an imaging device) that is disposed at a side of a vehicle and captures a rear view or side-rear view around the vehicle; a display device that outputs an image captured by the camera; and a control device configured to relay the image between the camera and the display device. The control device may be configured to calculate calibration information for calibrating an installation error of the camera; an area manager configured to set an extended area obtained by extending a reference area preset in an original image generated by the camera based on the calibration information; an image processor configured to extract an extended image corresponding to the extended area from the original image; and a transmitter configured to transmit a display image corresponding to a display area selected by a user within the extended image to the display device.

In one embodiment, the control device may further include a convenience information generator configured to generate user convenience information to be provided to the user for convenience in at least one of driving or parking of the vehicle.

In one embodiment, the image processor may be configured to align the user convenience information with an image output through the display device based on the calibration information.

In one embodiment, the image processor may be configured to: modify the user convenience information based on the calibration information to generate modified user convenience information; and synthesize the modified user convenience information with the display image.

In one embodiment, the user convenience information may include at least one of: driving convenience information that aids determining a distance to an object present in a side-rear region of the vehicle; or parking convenience information used to determine a distance of an area of a ground present in the side-rear region of the vehicle.

In one embodiment, the calibration information may include coordinate conversion information between a three-dimensional coordinate of the reference area within an entire area of the original image and a three-dimensional coordinate of a calibration area based on which the installation error of the camera may be calibrated.

In one embodiment, the area manager may be configured to set the extended area such that a vertex farthest from a center of the original image, among vertices of both of the reference area and the calibration area, is included as a vertex of the extended area.

In one embodiment, the area manager may be configured to set the extended area such that a point at which an extension line that extends out from a boundary line of the reference area and an extension line that extends out from a boundary line of the calibration area intersect with each other is included as a vertex of the extended area.

In one embodiment, the area manager may be configured to set the extended area by extending the reference area without displacing the original image by the calibration information.

In one embodiment, the image processor may be configured to extract the display image corresponding to the display area selected by the user from the extended image.

In one embodiment, the image processor may be configured to use one of vertices of the extended area as a reference point for determining a position of the display area.

Details of further embodiments are included in the detailed description and drawings.

With the camera mirror system according to the embodiments of the present disclosure as described above, the screen information such as an On Screen Display (OSD) can be aligned with the image based on the calibration information for calibrating the installation error of a camera mirror provided in the vehicle, such that the limitation of image information provided to the user can be prevented.

In addition, the image information provided to the user can be extended by extending the reference area as a range in which the display image output through the display device can be displaced.

### BRIEF DESCRIPTION OF THE DRAWINGS

The above and other aspects and features of the present disclosure will become more apparent by illustrating in detail embodiments thereof with reference to the attached drawings, in which:

FIG. 1 is a diagram illustrating a vehicle equipped with a camera mirror system according to an embodiment of the present disclosure;

FIG. 2 is a diagram for illustrating a relationship between an original image and a reference area;

FIG. 3 is a diagram illustrating a relationship between a reference image and a display area;

FIG. 4 is a diagram for illustrating a relationship between a reference area and a calibration area;

FIG. 5 is a diagram illustrating that a pattern board is installed in side-rear of a vehicle;

FIG. 6 is a diagram for illustrating a principle in which an installation error of a camera is calibrated;

FIG. 7 is a diagram illustrating that user convenience information is synthesized with a display image;

FIG. 8 is a diagram illustrating that user convenience information is aligned with a display image;

FIG. 9 is a diagram for illustrating that user convenience information is modified;

FIG. 10 is a block diagram of a control device;

FIGS. 11 and 12 are diagrams for illustrating that 3D coordinates of an original image are calculated;

FIG. 13 is a diagram for illustrating that three-dimensional coordinates of a reference area are calculated;

FIG. 14 is a diagram for illustrating that three-dimensional coordinates of a calibration area are calculated;

FIG. 15 is a diagram for illustrating a difference between image information included in a reference area and a calibration area;

FIG. 16 is a diagram for illustrating that an extended area is set; and

FIG. 17 is a diagram for illustrating that 3D coordinates of an extended area are calculated.

### DETAILED DESCRIPTIONS

Hereinafter, exemplary embodiments of the present disclosure will be described in detail with reference to the accompanying drawings. Advantages and features of the present disclosure and methods of achieving the same will be apparent with reference to the embodiments described in detail below together with the accompanying drawings. However, the present disclosure is not limited to the embodiments disclosed below, but may be implemented in various different forms, and the exemplary embodiments are provided to complete the present disclosure and to fully inform the scope of the present disclosure to those skilled in the art to which the present disclosure belongs, and the present disclosure is only defined by the scope of the claims. The same reference numerals refer to the same components throughout the present disclosure.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an overly idealized or overly formal sense unless expressly so defined herein.

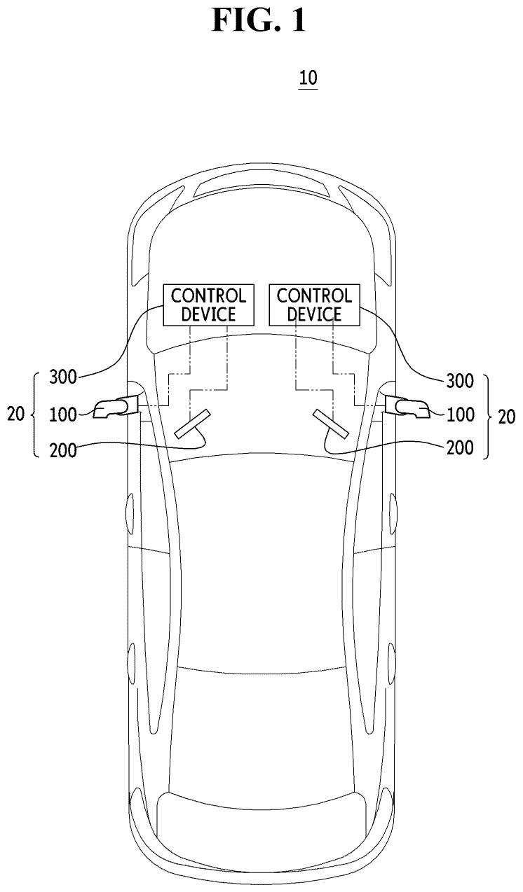

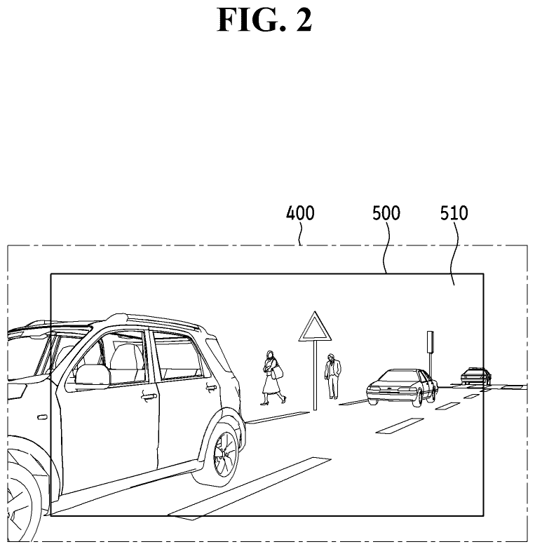

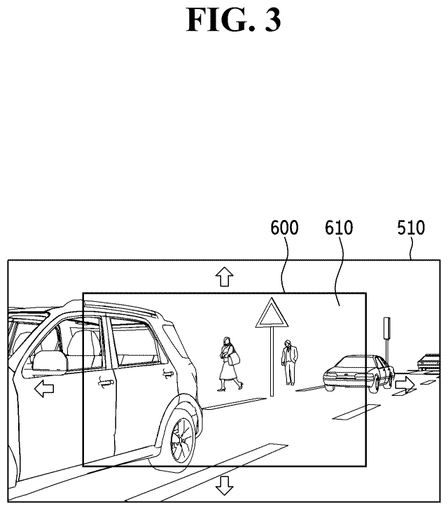

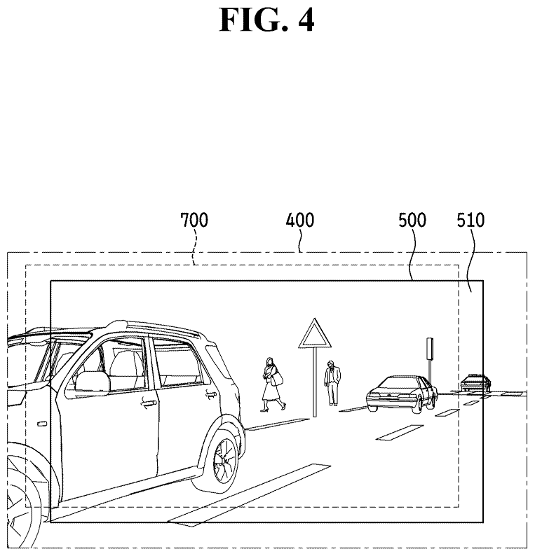

FIG. 1 is a diagram illustrating a vehicle equipped with a camera mirror system according to an embodiment of the present disclosure, FIG. 2 is a diagram illustrating a relationship between an original image and a reference area, FIG. 3 is a diagram illustrating a relationship between a reference image and a display area, and FIG. 4 is a diagram illustrating a relationship between a reference area and a calibration area.

Referring to FIG. 1, a vehicle 10 may include a camera mirror system 20. The camera mirror system 20 according to an embodiment of the present disclosure may include an image device (e.g., camera) 100, a display device 200, and a control device 300.

The camera 100 may be disposed at a side of the vehicle 10 to capture the rear or side-rear view around the vehicle 10. For example, the camera 100 may include an image sensor such as a charge coupled device (CCD) or a complementary metal oxide semiconductor (CMOS). Light input to the camera 100 may be sensed by the image sensor, and the sensed light may be converted into electrical signals to generate a digital image. The image generated by the camera 100 may be a surrounding image around the vehicle 10. Herein the digital image may refer to a series of digital images (e.g., digital video).

The display device 200 may output the image captured by the camera 100. Accordingly, the surrounding image acquired by the camera 100 may be displayed through the display device 200 provided inside the vehicle. Using the displayed image, the driver may perceive the situation of the rear or side-rear area around the vehicle 10. However, it is merely an example that the image captured by the camera 100 is an image of the rear or side-rear view around the vehicle 10. The camera 100 may acquire a surrounding image in at least one direction around the vehicle, which the driver may need to look.

Each display device 200 may be provided corresponding to each camera. That is, as shown in FIG. 1, the cameras 100 may be provided on each of both opposing sides of the vehicle 10, and each display device 200 corresponding to each camera 100 may be provided inside the vehicle 10. Each display device 200 may display an image captured by a corresponding camera 100. In some embodiments of the present disclosure, a single display device 200 may display images captured by both opposing cameras 100, or three or more display devices 200 may display the image captured by one camera 100 selected from both opposing cameras 100.

The control device 300 may be configured to relay an image between the camera 100 and the display device 200. In other words, an image captured by the camera 100 may be transmitted to the display device 200 through the control device 300, and the display device 200 may output the image received from the control device 300.

Referring to FIG. 2, the control device 300 may be configured to extract an image 510 of a predetermined area 500 from an image 400 of the camera 100. Hereinafter, the image 400 generated by the camera 100 is referred to as an original image, the area extracted by the control device 300 is referred to as a reference area 500, and the image included in the reference area 500 is referred to as a reference image 510.

The image output through the display device 200 may be included in a range of the reference area 500. That is, a portion of the original image 400 that is outside the range of the reference area 500 may not be output through the display device 200.

The reference area 500 represents a preset area of the original image 400 generated by the camera 100. For example, the size and coordinates of the reference area 500 may be predetermined, and the control device 300 may be configured to extract the reference area 500 from the original image 400 based on the predetermined size and coordinates.

Referring to FIGS. 2 and 3, the control device 300 may be configured to extract the reference image 510 corresponding to the preset reference area 500 from the original image 400 generated by the camera 100, and transmit a display image 610 corresponding to a display area 600, which is selected by a user (e.g., driver) from the reference image 510 to the display device 200. A size of the display area 600 may correspond to a displayable size of the display device 200. The user may check the display image 610 output through the display device 200.

The user may select a position of the display area 600 out of an entire area of the reference image 510. For example, the user may select the position of the display area 600 based on a user interface such as a button or a joystick provided in the vehicle 10. As the position of the display area 600 is adjusted, the display image 610 corresponding to the adjusted display area 600 may be output through the display device 200.

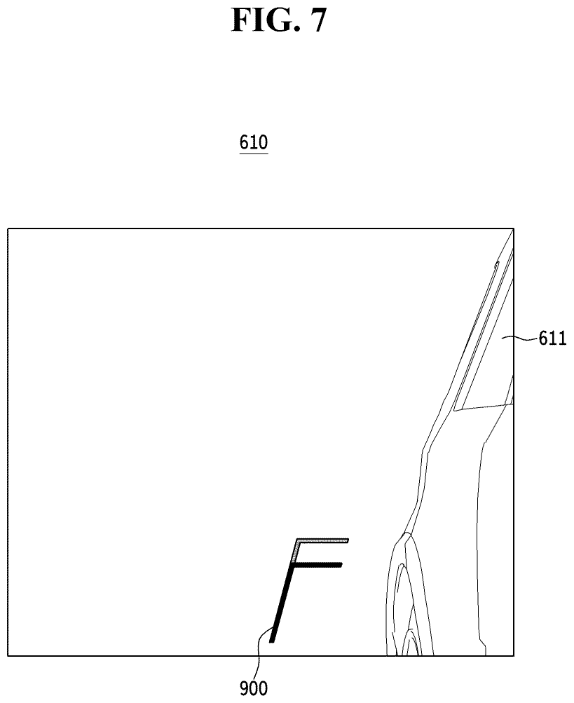

Referring back to FIG. 1, in accordance with the present disclosure, the control device 300 may be configured to align user convenience information 900 (see FIG. 7) with an image output through the display device 200 based on calibration information for calibrating an installation error of the camera 100.

When the camera mirror system 20 is mounted on the vehicle 10, an operation in which the camera 100 is installed on the vehicle 10 may be performed. In this case, the directions in which the installed cameras 100 are oriented may be varied each time. For example, even when the cameras 100 are installed in the same type of vehicle 10, the installation angles of the cameras 100 may be varied depending on different installation workers.

When an installation error (e.g., tolerance, variation, deviation, or misalignment) of the camera 100 occurs, the user convenience information 900 and the display image 610 may not be aligned with each other. In accordance with the present disclosure, the user convenience information 900 may indicate information provided to the user for convenience in at least one of driving or parking of the vehicle 10. For example, the user convenience information 900 may include at least one of driving convenience information or parking convenience information. The driving convenience information may represent information used to determine a distance of an object present in a side-rear region of the vehicle 10, and may be provided, for example, while the vehicle 10 is being driven. The parking convenience information may represent information used to determine a distance of an area of a ground present in the side-rear region of the vehicle 10, and may be provided, for example, while the user is parking the vehicle 10. The user convenience information 900 may be provided in the form of an On Screen Display (OSD). As the driving convenience information is displayed on the display image 610, the user may check the distance relationship between the vehicle 10 and another vehicle present in the side-rear region of the vehicle 10. In addition, as the parking convenience information is displayed on the display image 610, the user may check the distance relationship between a parking line drawn on the ground in the side-rear region of the vehicle 10 and the vehicle 10.

When the vehicle 10 is driven, the control device 300 may be configured to include the driving convenience information in the display image 610 and to transmit the display image including the driving convenience information to the display device 200. When the user is attempting to park the vehicle 10, for example, when the gear shift is put in the reverse position, the control device 300 may be configured to include the parking convenience information in the display image 610 and to transmit the display image including the parking convenience information to the display device 200.

An initial position in the display area 610 of the user convenience information 900 may be preset. When the user convenience information 900 is synthesized with the display image 610 at the initial position in the display image 610 with the installation error of the camera 100 having occurred, the display image 610 and the user convenience information 900 may not be aligned with each other. In this case, an error may occur to the distance relationship between the object included in the display image 610 and the user convenience information 900. In order to solve the misalignment problem between the display image 610 and the user convenience information 900, calibration or compensation for the installation error for the camera 100 may be performed.

Referring to FIG. 4, in order to calibrate the installation error of the camera 100, a calibration area 700 may be derived. The calibration area 700 may represent the reference area 500 whose position in the original image 400 has been adjusted in order to calibrate the installation error of the camera 100. The position of the reference area 500 may be adjusted in response to the installation error of the camera 100, and the calibration area 700 may be generated accordingly. The display area 600 may be set to be within the range of the calibration area 700, and accordingly, the display image 610 and the user convenience information 900 may be aligned with each other.

When the display area 600 is set to be within the range of the calibration area 700 that is the adjusted area from the reference area 500 whose the position has been adjusted, the image included in the display area 600 may be limited (e.g., cropped). For example, when the center of the calibration area 700 is displaced from the center of the original image 400 toward one side of the original image 400, the image information of the other side of the original image 400 may not be included in the display area 600.

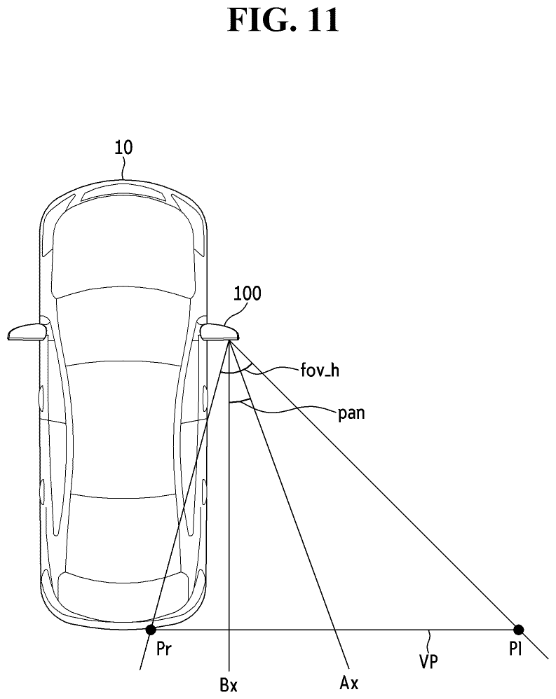

To address such an issue, the control device 300 of the present disclosure may be configured to align the user convenience information 900 with the display image 610 in a state in which the position of the reference area 500 is not adjusted. Specifically, the control device 300 may be configured to modify the user convenience information 900 using the calibration information, and synthesize the modified user convenience information 910 with the display image 610. In this regard, the calibration information may correspond to the installation error of the camera 100, and may include coordinate conversion information between the three-dimensional coordinates of the reference area 500 in the entire area of the original image 400 and the three-dimensional coordinates of the calibration area 700 based on which the installation error of the camera 100 is calibrated. A detailed description of the calculation of the calibration information will be described later with reference to FIGS. 11 to 14.

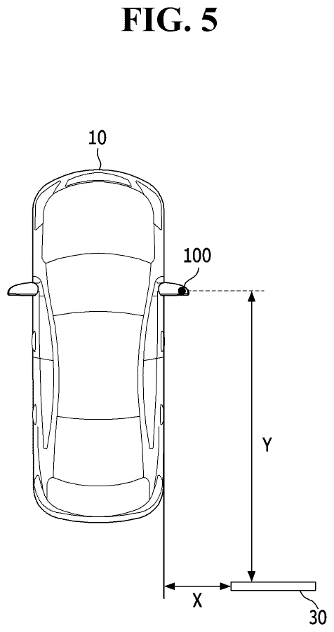

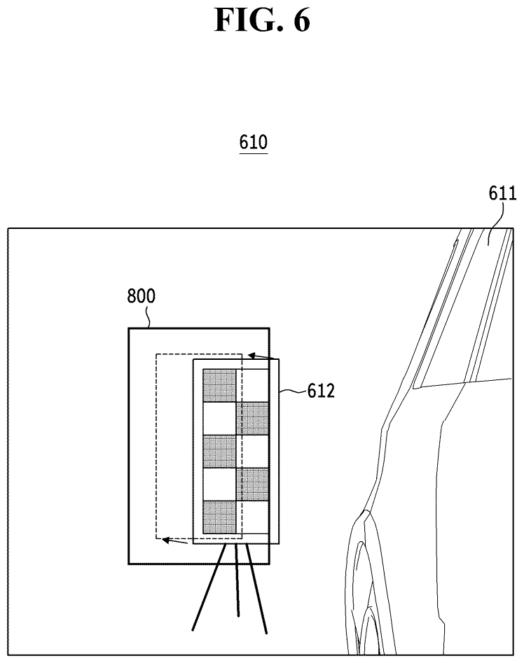

FIG. 5 is a diagram illustrating that a pattern board is installed in side-rear of a vehicle, and FIG. 6 is a diagram for illustrating a principle in which an installation error of a camera is calibrated.

Referring to FIGS. 5 and 6, in order to calibrate an installation error of the camera 100, a pattern board 30 may be installed in a side-rear region of the vehicle 10. For example, the pattern board 30 may be disposed at distances of X and Y in a width direction and a length direction, respectively, from the camera 100. In accordance with the present disclosure, the pattern board 30 may refer to a board on which patterns of dark and bright areas are arranged. In this regard, each of the dark area and the bright area may have a square or rectangular shape.

Referring to FIG. 6, the display device 200 may output a display image 610 received from the control device 300. The display image 610 may include a vehicle object 611 and a pattern board object 612. The vehicle object 611 may represent a portion of the vehicle 10, and the pattern board object 612 may represent the pattern board 30.

A reference area 800 may be included in the display image 610 for an error calibration operation. The reference area 800 may be generated by the control device 300 when an error calibration operation is performed. The reference area 800 may be a fixed specific area of the screen of the display device 200 and may provide a reference position of the pattern board object 612.

An arrangement deviation between the reference area 800 and the pattern board object 612 may correspond to a difference between the reference area 500 and the calibration area 700. As illustrated, when the center of the pattern board object 612 is misaligned with the center of the reference area 800, it may be determined that the reference area 500 and the calibration area 700 are misaligned with each other. The control device 300 may be configured to calculate the above-described calibration information with reference to the arrangement error between the reference area 800 and the pattern board object 612.

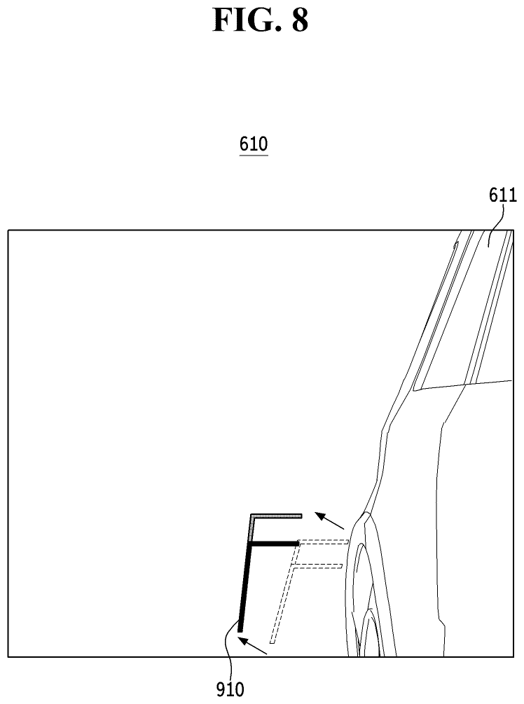

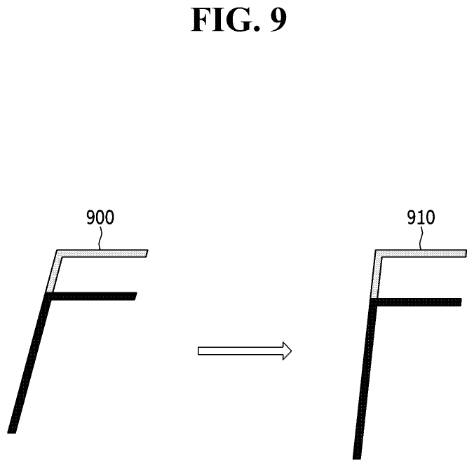

FIG. 7 is a diagram illustrating that user convenience information is synthesized with a display image, FIG. 8 is a diagram illustrating that user convenience information is aligned with a display image, and FIG. 9 is a diagram for illustrating that user convenience information is modified.

Referring to FIG. 7, the control device 300 may be configured to synthesize user convenience information 900 with the display image 610. The display image 610 may include the vehicle object 611 representing a portion of the vehicle 10 and user convenience information 900. The user convenience information 900 may be provided in the form of an on-screen display. The control device 300 may be configured to synthesize one of the driving convenience information or the parking convenience information with the display image 610 depending on the driving state of the vehicle 10. FIG. 7 illustrates an example where the parking convenience information is synthesized as the user convenience information 900 with the display image 610.

The initial position and initial form of the user convenience information 900 may be preset. When the user convenience information 900 is synthesized with the display image at the initial position thereof in the display image 610 in a state in which there is no installation error of the camera 100, the display image 610 and the user convenience information 900 may be aligned with each other. However, when the user convenience information 900 is included in the display image 610 at the initial position thereof in the display image 610 with the installation error of the camera 100, the display image 610 and the user convenience information 900 may not be aligned with each other.

The user convenience information 900 may include at least one figure. For example, the user convenience information 900 may include at least one line. It is preferable that the line included in the user convenience information 900 is parallel to the longitudinal direction of the vehicle 10 or the longitudinal direction of the parking line drawn on the ground. When the display image 610 and the user convenience information 900 are not aligned with each other, the line included in the user convenience information 900 may be inclined relative to the longitudinal direction of the vehicle 10 or the longitudinal direction of the parking line drawn on the ground. In this case, the user convenience information 900 may provide the user with information in which the installation error is included.

Referring to FIGS. 8 and 9, the control device 300 may be configured to modify the user convenience information 900 using the calibration information. Specifically, the control device 300 may be configured to modify the position and shape of the user convenience information 900 based on the calibration information. The line included in the modified user convenience information 910 may be parallel to the longitudinal direction of the vehicle 10 or the longitudinal direction of the parking line drawn on the ground, and the user may perform safe driving or parking with reference to the modified user convenience information 910.

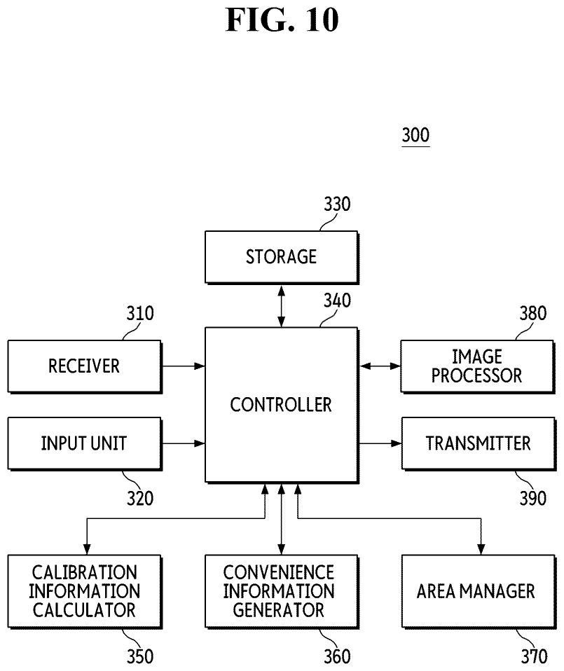

FIG. 10 is a block diagram of a control device. Referring to FIG. 10, the control device 300 may include a receiver 310, an input unit 320, storage 330, a controller 340, a calibration information calculator 350, a convenience information generator 360, an area manager 370, an image processor 380, and a transmitter 390.

The receiver 310 may receive the original image 400 from the camera 100. The receiver 310 may receive an image in real time while maintaining a communication channel with the camera 100.

The input unit 320 may receive a user command. For example, the user command may include a command for performing an error calibration operation and a command for moving the display area 600. In addition, the user command may include various commands for controlling the operation of the camera mirror system 20.

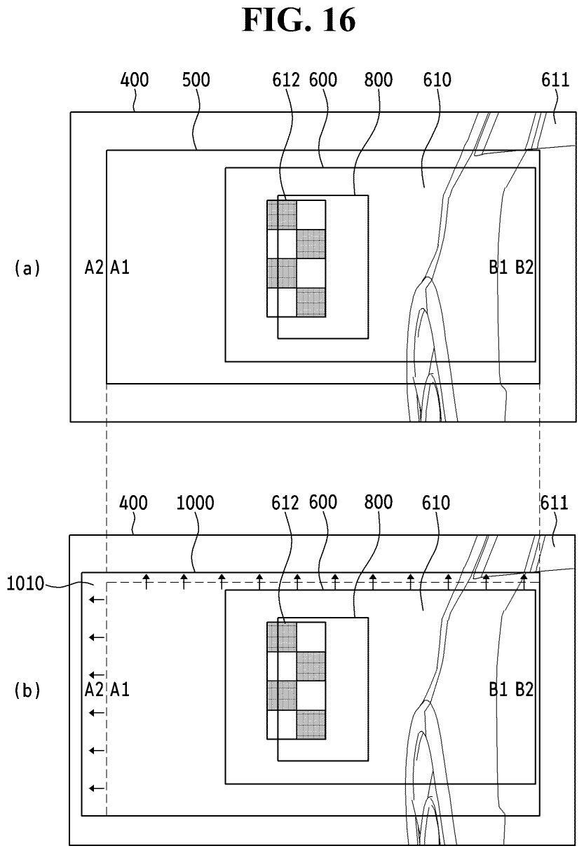

The storage 330 may store therein the calibration information. The calibration information may be calculated by the calibration information calculator 350 via an error calibration operation. In addition, the storage 330 may temporarily or permanently store therein the original image 400 received through the receiver 310, the user convenience information 900 generated by the convenience information generator 360, the coordinates of an extended area 1000 (see FIG. 16) set by the area manager 370, and the user convenience information 910 generated by the image processor 380. In addition, various information for the operation of the camera mirror system 20 may be temporarily or permanently stored in the storage 330.

The calibration information calculator 350 may calculate calibration information for compensating for the installation error of the camera 100. During the error calibration operation, the display image 610 may include the pattern board object and the reference area. By displacing the original image by the arrangement error between the reference area and the pattern board object, the reference area and the pattern board object may be aligned with each other. Accordingly, the calibration information calculator 350 may calculate the arrangement error between the reference area and the pattern board object as the calibration information.

The convenience information generator 360 may generate the user convenience information 900 to be provided to the user for convenience in at least one of driving or parking of the vehicle 10. The user convenience information 900 may include at least one of driving convenience information or parking convenience information, and may be provided in the form of an On Screen Display (OSD).

The area manager 370 may set the extended area 1000 (see FIG. 16) in which the preset reference area 500 in the original image generated by the camera 100 is extended using the calibration information. As the reference area 500 is extended by the calibration information, the extended area 1000 may be set.

The image processor 380 may receive the user convenience information 900 generated by the convenience information generator 360 and the extended area 1000 set by the area manager 370. The image processor 380 may extract an extended image 1010 (see FIG. 16) corresponding to the extended area 1000 from the original image, and extract the display image 610 corresponding to the display area 600 selected by the user from the extended image 1010. The user may select a position of the display area 600 in an entire area of the extended image 1010. For example, the user may select the position of the display area 600 based on a user interface such as a button, a joystick, or a touch screen interface provided in the vehicle 10. The image processor 380 may extract the display image 610 corresponding to the display area 600 selected by the user from the extended area 1000.

In addition, the image processor 380 may align the modified user convenience information 910 with the image output through the display device 200, that is, the display image 610, using the calibration information. Specifically, the image processor 380 may modify the user convenience information 900 using the calibration information, and synthesize the modified user convenience information 910 with the display image 610. As described with reference to FIGS. 8 and 9, the image processor 380 may modify the position and shape of the user convenience information 900 based on the calibration information.

The transmitter 390 may transmit the display image 610 to the display device 200. The display image 610 may have been aligned with the modified user convenience information 910. The display device 200 may output the display image 610 with which the modified user convenience information 910 has been aligned.

The controller 340 may be configured to perform overall control of the receiver 310, the input unit 320, the storage 330, the calibration information calculator 350, the convenience information generator 360, the area manager 370, the image processor 380, and the transmitter 390.

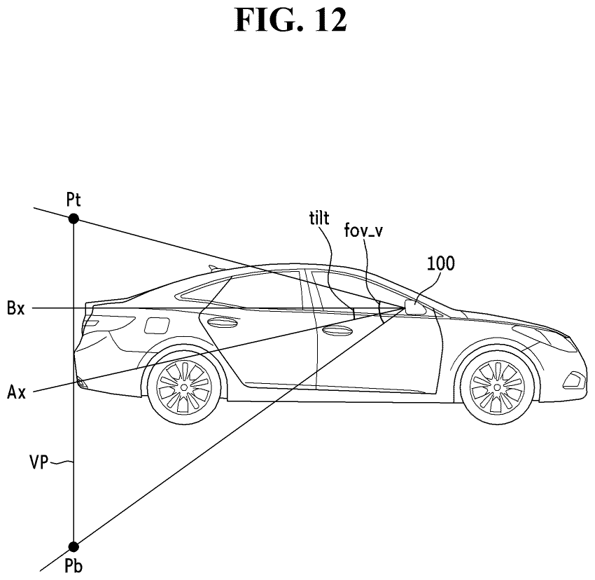

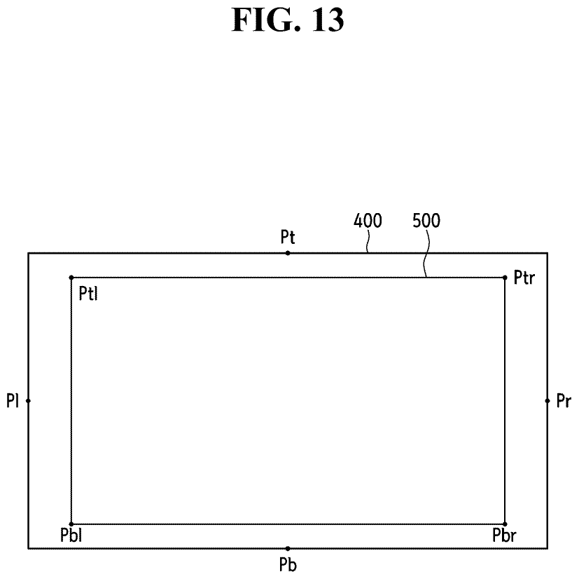

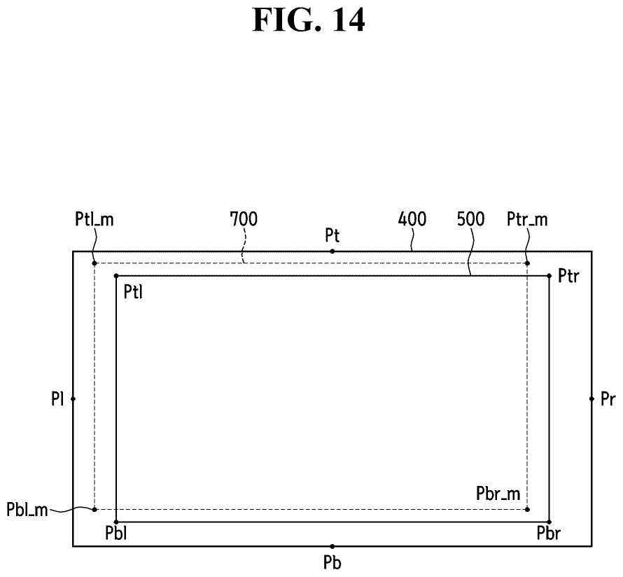

FIGS. 11 and 12 are diagrams for illustrating that three-dimensional coordinates of an original image are calculated, FIG. 13 is a diagram for illustrating that three-dimensional coordinates of a reference area are calculated, and FIG. 14 is a diagram for illustrating that three-dimensional coordinates of a calibration area are calculated.

Referring to FIG. 11, the camera 100 may capture images with a preset horizontal angle of view fov_h. Herein, the horizontal direction may indicate a direction parallel to the ground.

A capturing direction Ax of the camera 100 may be inclined by a predetermined angle (pan) in the horizontal direction with respect to a driving axis (e.g., longitudinal axis) Bx of the vehicle 10. In this regard, the driving axis Bx may represent a virtual axis connecting a front end and a rear end of the vehicle 10. The capturing direction Ax of the camera 100 may extend to be inclined outwardly from the vehicle 10 with respect to the driving axis Bx of the vehicle 10.

A portion of the virtual plane parallel to the rear end of the vehicle 10 may be included in the range of the horizontal angle of view fov_h of the camera 100. The virtual plane parallel to the rear end of the vehicle 10 may be perpendicular to the driving axis Bx of the vehicle 10.

Referring to FIG. 12, the camera 100 may capture images with a preset vertical angle of view fov_v. Herein, the vertical direction may indicate a direction perpendicular to the ground.

The capturing direction Ax of the camera 100 may be inclined by a predetermined angle (tilt) in the vertical direction with respect to the driving axis Bx of the vehicle 10. Specifically, the capturing direction Ax of the camera 100 may extend to be inclined downwardly of the vehicle 10 with respect to the driving axis Bx of the vehicle 10.

A portion of the virtual plane parallel to the rear end of the vehicle 10 may be included in the range of the vertical angle of view fov_v of the camera 100. Hereinafter, a virtual plane VP included in the range of the horizontal view angle fov_h and the vertical view angle fov_v of the camera 100 is referred to as a virtual plane VP.

The coordinates of an upper end point Pt, the coordinates of a lower end point Pb, the coordinates of a left end point Pl, and the coordinates of a right end point Pr of the virtual plane VP may be determined by referring to the specifications of the particular vehicle 10. For example, given the horizontal view angle fov_h of the camera 100, the vertical view angle fov_v of the camera 100, the capturing direction Ax of the camera 100, the distance between the camera 100 and the rear end of the vehicle 10, and the distance between the camera 100 and the ground, the coordinates of the upper end point Pt (hereinafter, referred to as upper end coordinates), the coordinates of the lower end point Pb (hereinafter, referred to as lower end coordinates), the coordinates of the left end point Pl (hereinafter, referred to as left end coordinates), and the coordinates of the right end point Pr (hereinafter, referred to as right end coordinates) of the virtual plane VP may be determined.

The upper end point Pt, the lower end point Pb, the left end point Pl, and the right end point Pr of the virtual surface VP may correspond to the upper end point Pt, the lower end point Pb, the left end point Pl, and the right end point Pr of the original image 400, respectively. The upper end coordinates, the lower end coordinates, the left end coordinates, and the right end coordinates may represent coordinates on the 3D space of the original image 400.

Referring to FIG. 13, the 3D coordinates of the reference area 500 may be determined based on the 3D coordinates of the original image 400. The reference area 500 may represent a preset area of the original image 400, and the size and coordinates of the reference area 500 in the original image 400 may be preset. Accordingly, the 3D coordinates of the original image 400 may be used to determine the 3D coordinates of the reference area 500. In accordance with the present disclosure, the three-dimensional coordinates of the reference area 500 may be represented by the coordinates of vertices Ptl, Ptr, Pbl, and Pbr.

Referring to FIG. 14, the 3D coordinates of the reference area 500 may be used to determine the 3D coordinates of the calibration area 700. In accordance with the present disclosure, the three-dimensional coordinates of the calibration area 700 may refer to three-dimensional coordinate result values or information of the calibration area 700 obtained by applying the installation error calibration result value to the reference area 500, and may be represented by vertices Ptl_m, Ptr_m, Pbl_m, and Pbr_m of the calibration area 700.

As described above, the pattern board 30 may be used to calibrate the error of the camera 100. During the error calibration operation, the arrangement error between the reference area 800 and the pattern board object 612 may be determined. The arrangement error between the reference area 800 and the pattern board object 612 may correspond to the difference between the reference area 500 and the calibration area 700. The three-dimensional coordinates of the calibration area 700 may be determined by applying the arrangement error between the reference area 800 and the pattern board object 612 to the reference area 500.

The control device 300 may be configured to modify the user convenience information 900 based on the coordinate conversion information. In this regard, the coordinate conversion information may indicate a difference between the three-dimensional coordinate of the reference area 500 and the three-dimensional coordinate of the calibration area 700. The modified user convenience information 910 may be calculated by modifying the position and shape of the user convenience information 900 based on the coordinate conversion information. For example, the control device 300 may be configured to calculate the modified user convenience information 910 by converting the user convenience information 900 using homography conversion or the like based on the coordinate conversion information. As the modified user convenience information 910 is synthesized with the display image 610, the user may drive and park the vehicle more safely.

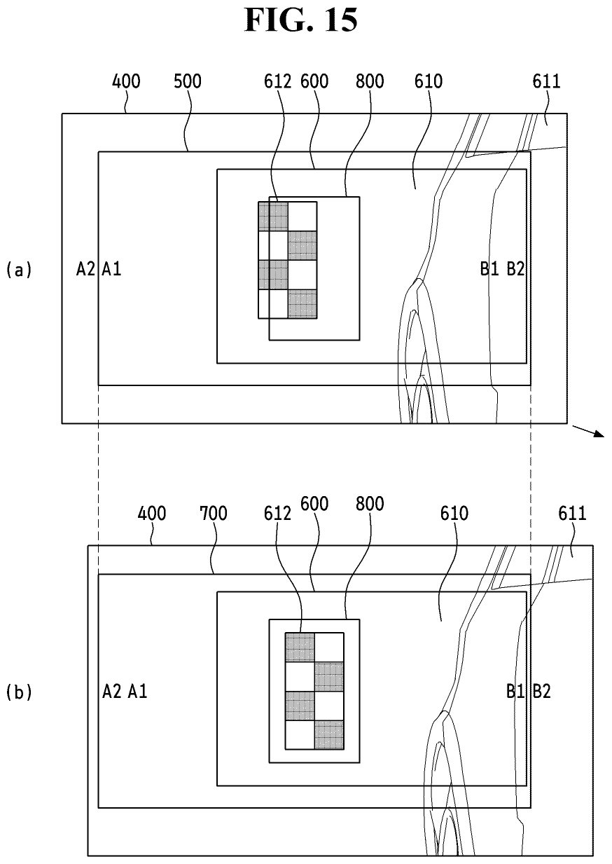

FIG. 15 is a diagram for illustrating a difference between image information included in the reference area and the calibration area. Referring to FIG. 15, as the installation error calibration is performed, image information included in the reference area 500 and image information included in the calibration area 700 may be adjusted.

In FIG. 15, panel (a) shows the original image 400, the reference area 500, and the display area 600 before the installation error calibration is performed, and panel (b) shows the original image 400, the calibration area 700, and the display area 600 after installation error calibration is performed.

The original image 400 may include the vehicle object 611 and the pattern board object 612. In addition, the original image 400 may include regions A1, A2, B1, and B2 as image information. The display image 610 may include the reference area 800. An installation error calibration may be performed by referring to the arrangement error between the reference area 800 and the pattern board object 612. Referring to FIG. 15, the original image 400 may be displaced to the lower right direction by the amount corresponding to the arrangement error between the reference area 800 and the pattern board object 612, such that the installation error may be compensated for.

Before the installation error calibration is performed, the reference area 500 may include regions A1, B1, and B2. The display area 600 may be displaced within the range of the reference area 500, and the display area 600 may selectively include regions A1, B1, and B2. After the installation error calibration is performed, the calibration area 700 may include A1, A2, and B1. The display area 600 may be displaced within the range of the calibration area 700, and therefore, the display area 600 may now include regions A1, A2, and B1, which are different from the regions that were originally included in the display area 600 prior to the calibration.

The image information that can be included in the display area 600 may vary depending on whether the installation error calibration is performed. Before the installation error calibration is performed, regions A1, B1, and B2 may be included in the display area 600. However, after the installation error calibration is performed, regions A1, A2, and B1 may be included in the display area 600. Before the installation error calibration is performed, the A2 region may not be included in the display area 600. After the installation error calibration is performed, the B2 region may not be included in the display area 600.

When the image information that can be included in the display area 600 varies depending on whether installation error calibration is performed, a sufficient field of view may not be secured to the driver. On the other hand, the camera mirror system 20 according to an embodiment of the present disclosure may provide sufficient image information to the driver regardless of whether installation error calibration is performed.

FIG. 16 is a diagram for illustrating that an extended area is set. Referring to FIG. 16, the area manager 370 of the control device 300 may set the extended area 1000 in which the preset reference area 500 in the original image 400 generated by the camera 100 is extended. In addition, the image processor 380 of the control device 300 may extract the extended image 1010 corresponding to the extended area 1000 from the original image 400, and the transmitter 390 of the control device 300 may transmit the display image 610 corresponding to the display area 600 selected by the user from the extended image 1010 to the display device 200.

In FIG. 16, panel (a) illustrates the original image 400, the reference area 500, and the display area 600, and panel (b) illustrates the original image 400, the extended area 1000, and the display area 600.

The area manager 370 may extend the reference area 500 to the extended area 1000 based on calibration information for calibrating the installation error of the camera 100. In this regard, the area manager 370 may set the extended area 1000 by extending the reference area 500 in a state in which the original image 400 is not displaced by the calibration information. Referring to FIG. 16, the area manager 370 may displace the vertex of the upper left end of the reference area 500 to the upper left direction by the amount of the arrangement error between the reference area 800 and the pattern board object 612, and may set the extended area 1000 having the displaced vertex. That is, the vertex of the lower right end of the extended area 1000 may be the same as the vertex of the lower right end of the reference area 500; the vertex of the upper left end of the extended area 1000 may be obtained by displacing the vertex of the upper left end of the reference area 500.

The extended area 1000 may include all of the image information in regions A1, A2, B1, and B2. The display area 600 may be displaced within the range of the extended area 1000, and the driver may check all of regions A1, A2, B1, and B2 according to his or her choice.

The extended area 1000 may be set in a state in which the original image 400 is not displaced by the calibration information for calibrating the installation error. In this case, the user convenience information 900 and the display image 610 may not be aligned with each other.

The image processor 380 may be configured to align the user convenience information 910 with the image output through the display device 200 based on the calibration information for calibrating the installation error of the camera 100. That is, the image processor 380 may modify the user convenience information 900 based on the calibration information and synthesize the modified user convenience information 910 with the display image 610. Since the alignment of the user convenience information 900 with the display image 610 has been described above, a detailed description thereof will be omitted.

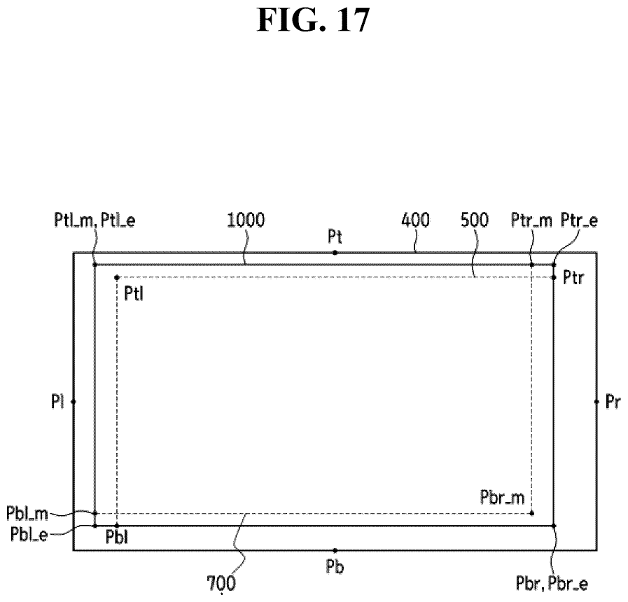

FIG. 17 is a diagram for illustrating that 3D coordinates of an extended area are calculated. Referring to FIG. 17, the 3D coordinates of the calibration area 700 may be determined based on the 3D coordinates of the reference area 500, and the 3D coordinates of the extended area 1000 may be determined based on the 3D coordinates of the reference area 500 and the 3D coordinates of the calibration area 700. The three-dimensional coordinates of the reference area 500 may be represented by vertices Ptl, Ptr, Pbl, and Pbr, the three-dimensional coordinates of the calibration area 700 may be represented by vertices Ptl_m, Ptr_m, Pbl_m, and Pbr_m, and the three-dimensional coordinates of the extended area 1000 may be represented by vertices Ptl_e, Ptr_e, Pbl_e, and Pbr_e. The 3D coordinates of the extended area 1000 may be determined by the area manager 370.

As described above, the pattern board 30 may be used to calibrate the instillation error of the camera 100. During the error calibration operation, the arrangement error between the reference area 800 and the pattern board object 612 may be determined. The arrangement error between the reference area 800 and the pattern board object 612 may correspond to the difference between the reference area 500 and the calibration area 700. The three-dimensional coordinates of the calibration area 700 may be determined by compensating for the arrangement error between the reference area 800 and the pattern board object 612 to the reference area 500.

In accordance with the present disclosure, the extended area 1000 may represent an area to which the reference area 500 is extended in the direction toward the calibration area 700, such that the extended area 1000 may encompass both the calibration area 700 and the reference area 500. Accordingly, the vertices of the extended area 1000 may include either a vertex of the reference area 500 or a vertex of the calibration area 700. Specifically, the area manager 370 may set the extended area 1000 so that the vertexes that are farthest from the center of the original image 400, among the vertices of the reference area 500 and the calibration area 700, are selected for the vertexes of the extended area 1000. In the example shown in FIG. 17, the vertex Pbr of the reference area 500 and the vertex Ptl_m of the calibration area 700 among the vertices of the reference area 500 and the calibration area 700 are disposed farthest from the center of the original image 400 compared to the vertex Pbr_m and the vertex Ptl, respectively. Accordingly, the vertex Ptl_e of the extended area 1000 may be set to correspond to the vertex Ptl_m of the calibration area 700, and the vertex Pbr_e may be set to correspond to the vertex Pbr of the reference area 500.

Stated another way, the area manager 370 may set the extended area 1000 so that a point at which an extension line that extends from a boundary line of the reference area 500 and an extension line that extends from a boundary line of the calibration area 700 meet with each other is included as the vertex of the extended area 1000. Referring to FIG. 17, the extension line that extends our from the boundary line connecting the vertices Ptl_m and Ptr_m of the calibration area 700 may intersect the extension line that extends our from the boundary line connecting the vertices Ptr and Pbr of the reference area 500. In addition, the extension line that extends out from the boundary line connecting the vertices Ptl_m and Pbl_m of the calibration area 700 may intersect the extension line that extends out from the boundary line connecting vertices Pbl and Pbr of the reference area 500. Accordingly, the vertex Ptr_e of the extended area 1000 may be determined as a point at which the boundary line connecting the vertices Ptl_m and Ptr_m of the calibration area 700 and the boundary line connecting the vertices Ptr and Pbr of the reference area 500 intersect with each other. In addition, the vertex Pbl_e of the extended area 1000 may be determined as a point at which the boundary line connecting the vertices Ptl_m and Pbl_m of the calibration area 700 and the boundary line connecting the vertices Pbl and Pbr of the reference area 500 intersect with each other.

As the reference area 500 is extended to the extended area 1000, the displacement range of the display area 600 may be extended, such that a greater amount of the image information may be provided to the driver.

The image processor 380 may be configured to modify the user convenience information 900 based on the coordinate conversion information. As described above, the coordinate conversion information may indicate a difference between the three-dimensional coordinate of the reference area 500 and the three-dimensional coordinate of the calibration area 700. The image processor 380 may generate the modified user convenience information 910 by converting the user convenience information 900 using homography conversion or the like based on the coordinate conversion information. As the modified user convenience information 910 is synthesized with the display image 610, the user may drive and park the vehicle more safely.

The position of the display area 600 in the extended area 1000 may be determined by the user's selection. The image processor 380 may use one of the vertices of the extended area 1000 as a reference point for determining the position of the display area 600. For example, the image processor 380 may use the vertex Ptl_e of the extended area 1000 as a reference point for determining the position of the display area 600. In this case, one of the vertices of the display area 600 may be a point spaced apart from the vertex Ptl_e in each of the horizontal and vertical directions.

Each unit, module, processor, controller, or any component included in the control device 300 described herein may be implemented using hardware, software, or a combination thereof. In one example, one or more functions of the unit, module, or processor may be implemented as computer programs, program instructions, or software modules executed by one or more processors included in a computing device or system. The software modules may be stored in a non-transitory computer-readable recording medium and configured to perform the corresponding operations when executed by the processor. Alternatively, some or all of the functions of the unit, module, or processor may be implemented using dedicated hardware components, such as application-specific integrated circuits (ASICs), digital signal processors (DSPs), or field-programmable gate arrays (FPGAs), without departing from the scope of the present disclosure. Although some aspects of the present disclosure have been described in the context of the apparatus, the aspects may indicate the corresponding descriptions according to a method, and the apparatus or components thereof may correspond to steps of a method or features of the steps.

Although the embodiments of the present disclosure have been described above with reference to the accompanying drawings, the present disclosure is not limited to the above embodiments. However, the present disclosure may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. A camera mirror system comprising:
a camera that is disposed at a side of a vehicle and captures a rear view or side-rear view around the vehicle;
a display device that outputs an image captured by the camera; and
a control device configured to relay the image between the camera and the display device,
wherein the control device includes:
a calibration information calculator configured to calculate calibration information for calibrating an installation error of the camera;
an area manager configured to set an extended area obtained by extending a reference area preset in an original image generated by the camera based on the calibration information;
an image processor configured to extract an extended image corresponding to the extended area from the original image; and
a transmitter configured to transmit a display image corresponding to a display area selected by a user within the extended image to the display device.

2. The camera mirror system of claim 1, wherein the control device further includes a convenience information generator configured to generate user convenience information to be provided to the user for convenience in at least one of driving or parking of the vehicle.

3. The camera mirror system of claim 2, wherein the image processor is configured to align the user convenience information with an image output through the display device based on the calibration information.

4. The camera mirror system of claim 3, wherein the image processor is configured to:
modify the user convenience information based on the calibration information to generate modified user convenience information; and
synthesize the modified user convenience information with the display image.

5. The camera mirror system of claim 2, wherein the user convenience information includes at least one of:
driving convenience information that aids determining a distance to an object present in a side-rear region of the vehicle; or
parking convenience information used to determine a distance of an area of a ground present in the side-rear region of the vehicle.

6. The camera mirror system of claim 1, wherein the calibration information includes coordinate conversion information between a three-dimensional coordinate of the reference area within an entire area of the original image and a three-dimensional coordinate of a calibration area based on which the installation error of the camera is calibrated.

7. The camera mirror system of claim 6, wherein the area manager is configured to set the extended area such that a vertex farthest from a center of the original image, among vertices of both of the reference area and the calibration area, is included as a vertex of the extended area.

8. The camera mirror system of claim 7, wherein the area manager is configured to set the extended area such that a point at which an extension line that extends out from a boundary line of the reference area and an extension line that extends out from a boundary line of the calibration area intersect with each other is included as a vertex of the extended area.

9. The camera mirror system of claim 1, wherein the area manager is configured to set the extended area by extending the reference area without displacing the original image by the calibration information.

10. The camera mirror system of claim 1, wherein the image processor is configured to extract the display image corresponding to the display area selected by the user from the extended image.

11. The camera mirror system of claim 10, wherein the image processor is configured to use one of vertices of the extended area as a reference point for determining a position of the display area.
